(19) United States
(12) Patent Application Publication
(10) Pub. No.: US 2026/0251161 A1
(43) Pub. Date: Aug. 27, 2026

(54) FIXING STRUCTURE FOR LAMINAR FLOW ELEMENT AND FLOW RATE CONTROL DEVICE

(71) Applicant: FUJIKIN INCORPORATED, Osaka-shi (JP)

(72) Inventors: Takuro MURATA, Osaka-shi (JP); Tomokazu HIROTA, Osaka-shi (JP); Hironori KOBAYASHI, Osaka-shi (JP); Hiroyuki ITO, Osaka-shi (JP)

(21) Appl. No.: 19/650,558

(22) Filed: Apr. 17, 2026

Related U.S. Application Data
(63) Continuation of application No. PCT/JP2024/032718, filed on Sep. 12, 2024.

(30) Foreign Application Priority Data
Oct. 20, 2023 (JP) 2023-180736

(51) Int. Cl. F15D 1/06; F15D 1/00

(52) U.S. Cl. CPC F15D 1/06; F15D 1/0025

(57) ABSTRACT

A fixing structure for a laminar flow element fixed to a flow path block having a flow path includes a press-fit member press-fitted and fixed to the flow path, and an elastic body interposed between the press-fit member and the laminar flow element. The laminar flow element is configured to be fixed to the flow path block by an elastic force that is generated by the press-fit member pressing the elastic body and that acts on the laminar flow element.

### CROSS REFERENCE TO RELATED APPLICATION

This application is a continuation application under 35 U.S.C. § 120 of No. PCT/JP 2024/032718, filed Sep. 12, 2024, which is incorporated herein by reference, and which claims priority to Japanese Application No. 2023-180736, filed Oct. 20, 2023. The present application likewise claims priority under 35 U.S.C. § 119 to Japanese Application No. 2023-180736, filed Oct. 20, 2023, the entire content of which is also incorporated herein by reference.

### TECHINICAL FIELD

The present disclosure relates to a fixing structure for a laminar flow element used in a fluid control device for use in semiconductor manufacturing equipment and the like, and to a flow rate control device including the fixing structure.

### BACKGROUND

Japanese Patent No. 4162227 discloses a flow rate control device including a block body, a flow straightener assembled to the block body, a flow rate sensor assembled to a flow path, and a flow-rate adjustment valve mechanism assembled on the downstream side of the flow path. The flow straightener is assembled to the block body by fitting the flow straightener into the block body, assembling a spring member and a spacer to an end portion of the flow straightener, covering them with a lid member, and fixing the lid member to the block body with screws. There is also a fluid control device in which a flow straightener (laminar flow element) is fixed to a housing by press-fitting.

### SUMMARY

However, in the flow straightener of Japanese Patent No. 4162227, since the lid member is fixed to the block body with screws, gas stagnation may occur around the screws, and the screws may loosen. When the laminar flow element is fixed to the housing by press-fitting, no force acts to further push the laminar flow element after fixing, and thus the laminar flow element cannot be brought into sufficiently close contact. Fixing by welding is also possible; however, welding deteriorates corrosion resistance, and with corrosive gas there arises a risk that corrosion occurs.

Accordingly, the present disclosure is to provide a fixing structure for a laminar flow element, and a flow rate control device, which can prevent gas stagnation and can fix the laminar flow element in sufficiently close contact.

A fixing structure for a laminar flow element according to one aspect of the present disclosure is a fixing structure for a laminar flow element fixed to a flow path block having a flow path, and includes a press-fit member press-fitted and fixed to the flow path, and an elastic body interposed between the press-fit member and the laminar flow element. The laminar flow element is configured to be fixed to the flow path block by an elastic force that is generated by the press-fit member pressing the elastic body and that acts on the laminar flow element.

### BRIEF DESCRIPTION OF THE DRAWINGS

In the drawings:

FIG. 1 is a schematic view of a flow rate control device according to an embodiment;

FIG. 2 is an exploded perspective view of a first flow path block, a press-fit unit, and a mesh portion according to a first embodiment;

FIG. 3 is an exploded perspective view of the press-fit unit according to the first embodiment;

FIG. 4 is a cross-sectional view of the first flow path block, the press-fit unit, and the mesh portion according to the first embodiment;

FIG. 5 is an exploded perspective view of a press-fit unit according to a second embodiment;

FIG. 6 is a cross-sectional view of the first flow path block, the press-fit unit, and the mesh portion according to the second embodiment;

FIG. 7 is an exploded perspective view of a press-fit unit according to a third embodiment;

FIG. 8 is a cross-sectional view of the first flow path block, the press-fit unit, and the mesh portion according to the third embodiment;

FIG. 9 is an exploded perspective view of a press-fit unit according to a fourth embodiment; and

FIG. 10 is a cross-sectional view of the first flow path block, the press-fit unit, and the mesh portion according to the fourth embodiment.

### DETAILED DESCRIPTION

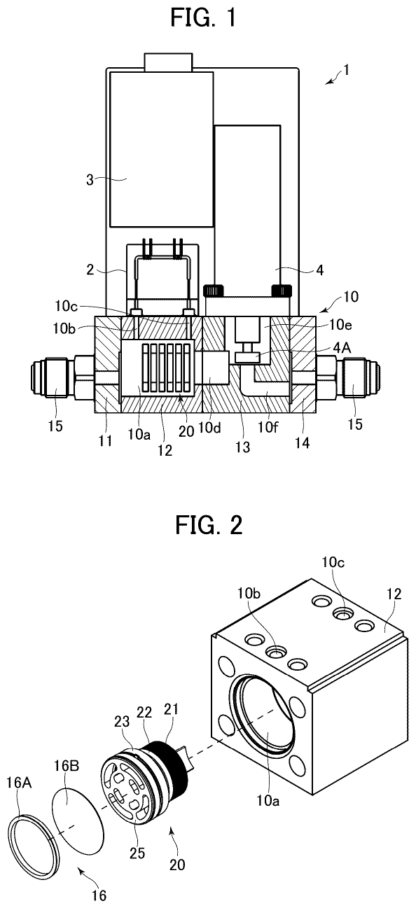

A fixing structure for a laminar flow element and a flow rate control device including the fixing structure according to a first embodiment of the present disclosure will be described with reference to the drawings. FIG. 1 is a schematic view of a flow rate control device 1 according to the embodiment.

The flow rate control device 1 mainly includes a body 10, a flow rate sensor 2, a controller 3, and a control valve device 4. The flow rate control device is, for example, a mass flow controller.

The body 10 is made of a steel material such as stainless steel and has a rectangular parallelepiped outer shape. The body 10 includes a first joint block 11, a first flow path block 12, a second flow path block 13, a second joint block 14, and two joints 15. The first joint block 11, the first flow path block 12, the second flow path block 13, and the second joint block 14 are connected to each other in this order by bolts and the like. The joints 15 are connected to the first joint block 11 and the second joint block 14. A bypass flow path 10a, a sensor inflow path 10b, a sensor outflow path 10c, a merging path 10d, a valve chamber 10e, and an outflow path 10f are formed in the first flow path block 12 and the second flow path block 13.

A fluid that has passed through the joint 15 and the first joint block 11 flows into the bypass flow path 10a. The sensor inflow path 10b branches from the bypass flow path 10a and causes the fluid to flow to the flow rate sensor 2. The sensor outflow path 10c causes the fluid that has passed through the flow rate sensor 2 to flow out. In the merging path 10d, the fluid that has passed through the bypass flow path 10a and the fluid that has passed through the sensor outflow path 10c merge. The bypass flow path 10a and the sensor inflow path 10b are configured such that the fluid flows at a predetermined flow-rate ratio (for example, 1:2 to 1:1000). A press-fit unit 20 and a mesh portion 16, to be described later, are installed in the bypass flow path 10a. A flow-rate control valve 4A of the control valve device 4 is disposed in the valve chamber 10e.

The flow rate sensor 2 is a thermal flow rate sensor. Based on the flow rate of the fluid measured by the flow rate sensor 2, the controller 3 outputs a valve drive signal to the control valve device 4 such that the fluid flowing through the bypass flow path 10a attains a predetermined flow rate. The flow-rate control mechanism 4 drives the flow-rate control valve 4A based on the valve drive signal from the controller 3.

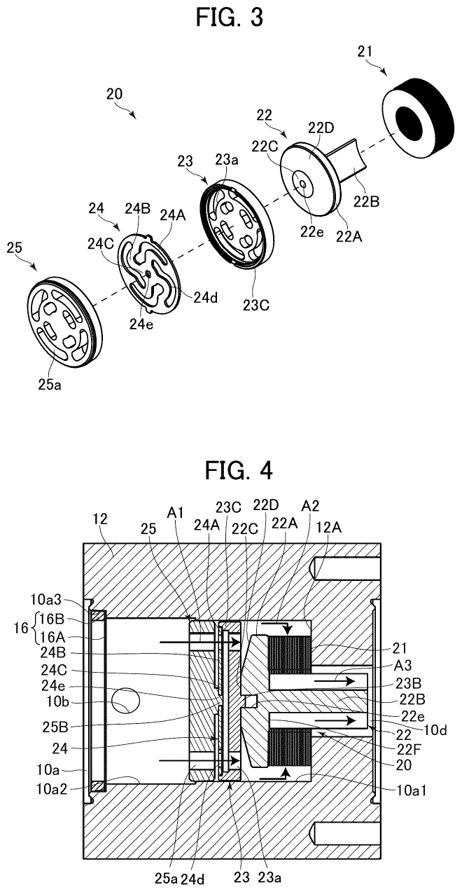

FIG. 2 is an exploded perspective view of the first flow path block 12, the press-fit unit 20, and the mesh portion 16 according to the first embodiment. FIG. 3 is an exploded perspective view of the press-fit unit 20 according to the first embodiment. FIG. 4 is a cross-sectional view of the first flow path block 12, the press-fit unit 20, and the mesh portion 16 according to the first embodiment. In FIG. 2 and FIG. 3, the lower-left side is the upstream side in the fluid flow direction and the upper-right side is the downstream side in the fluid flow direction. In FIG. 4, the left side is the upstream side in the fluid flow direction and the right side is the downstream side in the fluid flow direction.

As illustrated in FIG. 4, the bypass flow path 10a includes a downstream passage 10a1, an intermediate passage 10a2, and an upstream passage 10a3. The inner diameter of the upstream passage 10a3 is larger than the inner diameter of the intermediate passage 10a2, and the inner diameter of the intermediate passage 10a2 is larger than the inner diameter of the downstream passage 10a1. The inner diameter of the merging path 10d is smaller than the inner diameter of the downstream passage 10a1.

As illustrated in FIG. 2 to FIG. 4, the press-fit unit 20 includes a laminar flow element 21, a seat pressing member 22, a spring receiver 23, a disc spring 24, and a press-fit collar 25. These members constituting the press-fit unit 20 are made of a steel material such as stainless steel. The laminar flow element 21 is formed into a cylindrical shape by stacking a plurality of bypass sheets. When the fluid flows through the inside of the laminar flow element 21, the flow becomes laminar. The laminar flow element 21 abuts a stepped surface 12A of the first flow path block 12.

The seat pressing member 22 includes a pressing portion 22A and a penetrating portion 22B. The pressing portion 22A has a generally disk shape. On its upstream side, the pressing portion 22A has a flat abutment surface 22C and an inclined surface 22D. The abutment surface 22C is located at the central portion of the pressing portion 22A, and the inclined surface 22D is located on the outer periphery of the abutment surface 22C. A recess 22e is formed at the center of the abutment surface 22C. On its downstream side, the pressing portion 22A has a pressing surface 22F. The penetrating portion 22B has a columnar shape, extends downstream from the central portion of the pressing surface 22F, and penetrates the laminar flow element 21. An end portion of the penetrating portion 22B is located in the merging path 10d. The penetrating portion 22B has a generally deltoid (three-lobed) shape in longitudinal cross section. The three outer end portions of the penetrating portion 22B are configured to abut on the inner peripheral surface of the laminar flow element 21.

The spring receiver 23, which is an auxiliary member, has a generally disk shape and is located on the upstream side of the seat pressing member 22. A plurality (eight) of through-holes 23a are formed in the spring receiver 23. Four through-holes 23a are formed on the inner peripheral side and four through-holes 23a are formed on the outer peripheral side. The spring receiver 23 has a protrusion 23B at the central portion on the downstream side. The protrusion 23B is fitted into the recess 22e. An annular receiving portion 23C protruding upstream is provided on the outer peripheral portion of the spring receiver 23.

The disc spring 24, which is an elastic body, is a generally disk-shaped spring and is located on the upstream side of the spring receiver 23. The disc spring 24 includes an outer peripheral portion 24A, an intermediate portion 24B, and a central portion 24C. The outer peripheral portion 24A has an annular shape and has two protrusions projecting outward. These protrusions are configured to fit into two grooves of the receiving portion 23C. The outer peripheral portion 24A is supported by the receiving portion 23C. A plurality (four) of through-holes 24d are formed in the intermediate portion 24B. Each through-hole 24d is formed so as to overlap, in the fluid flow direction, one through-hole 23a on the inner peripheral side and one through-hole 23a on the outer peripheral side. A fitting hole 24e is formed at the center of the central portion 24C.

The press-fit collar 25, which is a press-fit member, has a generally disk shape and is located on the upstream side of the disc spring 24. A plurality (eight) of through-holes 25a are formed in the press-fit collar 25. Four through-holes 25a are formed on the inner peripheral side and four through-holes 25a are formed on the outer peripheral side. The four through-holes 25a on the inner peripheral side are formed so as to overlap, in the fluid flow direction, inner-peripheral portions of the four through-holes 24d and the through-holes 23a on the inner peripheral side. The four through-holes 25a on the outer peripheral side are formed so as to overlap, in the fluid flow direction, outer-peripheral portions of the four through-holes 24d and the through-holes 23a on the outer peripheral side. A two-step protrusion 25B projecting downstream is provided at the center of the press-fit collar 25. An end portion of the protrusion 25B is fitted into the fitting hole 24e.

The press-fit collar 25 is press-fitted into the downstream passage 10a1, whereby the press-fit collar 25 is fixed to the first flow path block 12. The protrusion 25B of the press-fit collar 25 pushes the central portion 24C of the disc spring 24 downstream, thereby causing the central portion 24C to deflect downstream. As a result, an elastic force of the disc spring 24 acts on the spring receiver 23 via the outer peripheral portion 24A, pushing the spring receiver 23 downstream, and the central portion of the spring receiver 23 presses the seat pressing member 22 downstream. Consequently, the laminar flow element 21 is clamped between the pressing portion 22A of the seat pressing member 22 and the stepped surface 12A of the first flow path block 12 and is fixed to the first flow path block 12 in close contact without any gap.

As indicated by arrows A1 to A3 in FIG. 4, the fluid passes through the through-holes 25a, 24d, and 23a, passes through a gap between the spring receiver 23 and the inclined surface 22D, then flows through the inside of the laminar flow element 21, and flows into the merging path 10d.

The mesh portion 16 includes a mesh 16A and a mesh ferrule 16B. The disk-shaped mesh 16A is disposed in the upstream passage 10a3. The annular mesh ferrule 16B is press-fitted into the upstream passage 10a3, whereby the mesh 16A is fixed to the first flow path block 12.

As described above, the fixing structure for the laminar flow element according to the present embodiment includes the press-fit collar 25 press-fitted and fixed to the downstream passage 10a1 of the bypass flow path 10a, and the disc spring 24 interposed between the press-fit collar 25 and the laminar flow element 21. The elastic force generated by the press-fit collar 25 pressing the disc spring 24 acts on the laminar flow element 21, whereby the laminar flow element 21 is configured to be fixed in close contact with the first flow path block 12 without any gap. Accordingly, gas stagnation is prevented in the bypass flow path 10a, and the bypass sheets constituting the laminar flow element 21 can be brought into sufficiently close contact.

The elastic force of the disc spring 24 is configured to act on the laminar flow element 21 via the spring receiver 23. The protrusion 23B of the spring receiver 23 is fitted into the recess 22e of the seat pressing member 22. This can suppress the influence of tolerances of parts such as the seat pressing member 22 and can suppress axial misalignment of the disc spring 24. Therefore, the spring receiver 23 functions as an auxiliary member that assists the manner in which the elastic force of the disc spring 24 acts on the laminar flow element 21.

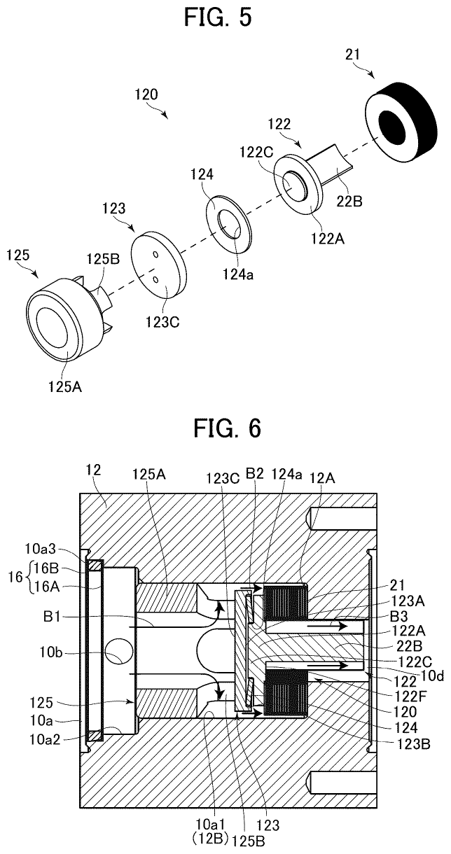

Next, a fixing structure for a laminar flow element according to a second embodiment will be described. FIG. 5 is an exploded perspective view of a press-fit unit 120 according to the second embodiment, and FIG. 6 is a cross-sectional view of the first flow path block 12, the press-fit unit 120, and the mesh portion 16 according to the second embodiment. Members that are the same as those of the press-fit unit 20 according to the first embodiment are denoted by the same reference numerals, and description thereof is omitted.

The press-fit unit 120 includes the laminar flow element 21, a seat pressing member 122, a coned disc spring 124, a spring receiver 123, and a plug 125. These members constituting the press-fit unit 120 are made of a steel material such as stainless steel.

The seat pressing member 122 includes a pressing portion 122A and the penetrating portion 22B. The pressing portion 122A has a generally disk shape. A disk-shaped protrusion 122C is provided at the central portion on the upstream side of the pressing portion 122A. The pressing portion 122A has a pressing surface 122F on the downstream side. The penetrating portion 22B extends downstream from the central portion of the pressing surface 122F and penetrates the laminar flow element 21.

The coned disc spring 124, which is an elastic body, is located on the upstream side of the seat pressing member 122. A through-hole 124a of the coned disc spring 124 is configured to fit onto the protrusion 122C of the seat pressing member 122. The coned disc spring 124 is arranged such that its outer peripheral end is located on the upstream side of its inner peripheral end.

The spring receiver 123, which is an auxiliary member, has a generally disk shape and is located on the upstream side of the coned disc spring 124. An outer peripheral portion of the coned disc spring 124 abuts a downstream surface 123A of the spring receiver 123. An annular protrusion 123B projecting downstream is provided on the outer peripheral edge of the spring receiver 123. The outer peripheral portion of the coned disc spring 124 is located inside the protrusion 123B.

The plug 125, which is a press-fit member, includes a cylindrical portion 125A and four leg portions 125B. The cylindrical portion 125A is press-fitted into the downstream passage 10a1. The four leg portions 125B extend downstream from the cylindrical portion 125A and are curved inward so as to be spaced apart from an inner peripheral surface 12B forming the downstream passage 10a1. Accordingly, a gap is formed between the four leg portions 125B and the inner peripheral surface 12B. An end portion of each leg portion 125B abuts the upstream surface 123C of the spring receiver 123.

The cylindrical portion 125A is press-fitted into the downstream passage 10a1, whereby the plug 125 is fixed to the first flow path block 12. The four leg portions 125B of the plug 125 push the upstream surface 123C of the spring receiver 123 downstream, thereby causing the coned disc spring 124 to deflect. As a result, an elastic force of the coned disc spring 124 acts on the pressing portion 122A of the seat pressing member 122 via the spring receiver 123, thereby pressing the seat pressing member 122 downstream. Consequently, the laminar flow element 21 is clamped between the pressing portion 122A of the seat pressing member 122 and the stepped surface 12A of the first flow path block 12, and the laminar flow element 21 is fixed to the first flow path block 12 in close contact without any gap.

As indicated by arrows B1 to B3 in FIG. 6, the fluid passes through the inside of the cylindrical portion 125A, between adjacent leg portions 125B, and through a gap between the leg portions 125B and the inner peripheral surface 12B, then flows through the inside of the laminar flow element 21, and flows into the merging path 10d.

As described above, the fixing structure for the laminar flow element according to the present embodiment includes the plug 125 press-fitted and fixed to the downstream passage 10a1 of the bypass flow path 10a, and the coned disc spring 124 interposed between the plug 125 and the laminar flow element 21. The elastic force generated by the plug 125 pressing the coned disc spring 124 acts on the laminar flow element 21, whereby the laminar flow element 21 is configured to be fixed in close contact with the first flow path block 12 without any gap. Accordingly, gas stagnation is prevented in the bypass flow path 10a, and the bypass sheets constituting the laminar flow element 21 can be brought into sufficiently close contact.

A disk-shaped spring receiver 123 pushed by the plug 125 presses the coned disc spring 124 so that the elastic force of the coned disc spring 124 acts on the laminar flow element 21. Accordingly, the elastic force of the coned disc spring 124 can be sufficiently applied to the laminar flow element 21. Therefore, the spring receiver 123 functions as an auxiliary member that assists the manner in which the elastic force of the coned disc spring 124 acts on the laminar flow element 21.

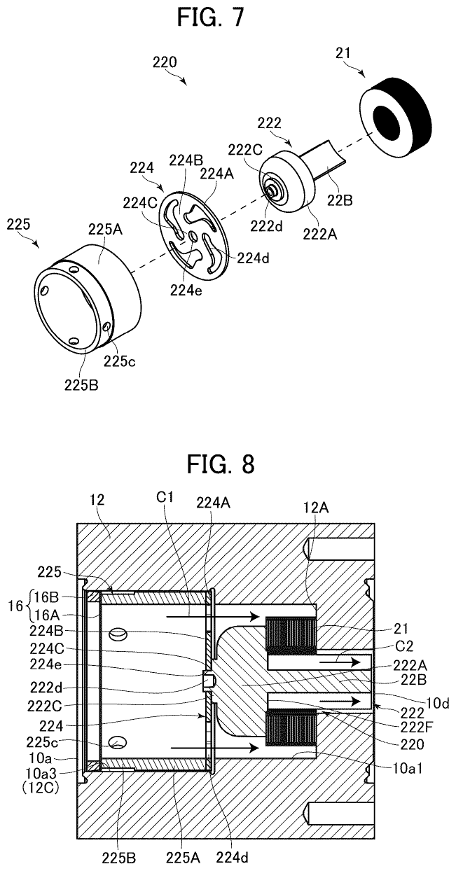

Next, a fixing structure for a laminar flow element according to a third embodiment will be described. FIG. 7 is an exploded perspective view of a press-fit unit 220 according to the third embodiment, and FIG. 8 is a cross-sectional view of the first flow path block 12, the press-fit unit 220, and the mesh portion 16 according to the third embodiment. Members that are the same as those of the press-fit unit 20 according to the first embodiment are denoted by the same reference numerals, and description thereof is omitted.

The press-fit unit 220 includes the laminar flow element 21, a seat pressing member 222, a disc spring 224, and a bypass adapter 225. These members constituting the press-fit unit 220 are made of a steel material such as stainless steel.

The seat pressing member 222 includes a pressing portion 222A and a penetrating portion 22B. The pressing portion 222A has a generally hemispherical shape. A two-step protrusion 222C is provided at the central portion (apex) on the upstream side of the pressing portion 222A. A recess 222d is formed at the center of a distal end portion of the protrusion 222C. The pressing portion 222A has a pressing surface 222F on a downstream side thereof. The through portion 222B has a columnar shape, extends downstream from a central portion of the pressing surface 222F, and passes through the laminar flow element 21.

The disc spring 224, which is an elastic body, is a generally disk-shaped spring and is located on the upstream side of the seat pressing member 222. The disc spring 224 includes an outer peripheral portion 224A, an intermediate portion 224B, and a central portion 224C. The outer peripheral portion 224A has an annular shape. A plurality (four) of through-holes 224d are formed in the intermediate portion 224B. Each through-hole 224d is configured, similarly to the through-hole 24d of the first embodiment, by a portion located on the inner peripheral side and a portion located on the outer peripheral side. A fitting hole 224e is formed at the center of the central portion 224C. A distal end portion of the protrusion 222C is fitted into the fitting hole 224e. Accordingly, the seat pressing member 222 and the disc spring 224 are integrated with each other.

The bypass adapter 225, which is a press-fit member, has a cylindrical shape and is located on the upstream side of the disc spring 224. The bypass adapter 225 includes a press-fit portion 225A and a flow passage portion 225B. The press-fit portion 225A is press-fitted into the upstream passage 10a3. The flow passage portion 225B is located on the upstream side of the press-fit portion 225A. An outer diameter of the flow passage portion 225B is configured to be smaller than an outer diameter of the press-fit portion 225A. A gap is formed between the flow passage portion 225B and an inner peripheral surface 12C forming the upstream passage 10a3. Through-holes 225c are formed in the flow passage portion 225B.

The press-fit portion 225A is press-fitted into the upstream passage 10a3, whereby the bypass adapter 225 is fixed to the first flow path block 12. The press-fit portion 225A pushes the outer peripheral portion 224A of the disc spring 224 downstream, thereby causing the disc spring 224 to deflect. As a result, an elastic force of the disc spring 224 acts on the pressing portion 222A of the seat pressing member 222 via the central portion 224C, thereby pressing the seat pressing member 222 downstream. Consequently, the laminar flow element 21 is clamped between the pressing portion 222A of the seat pressing member 222 and the stepped surface 12A of the first flow path block 12, and the laminar flow element 21 is fixed to the first flow path block 12 in close contact without any gap.

As indicated by arrows C1 to C2 in FIG. 8, the fluid passes through the inside of the bypass adapter 225 and the through-holes 224d of the disc spring 224, then flows through the inside of the laminar flow element 21, and flows into the merging path 10d.

The mesh 16A is disposed at an end portion of the flow passage portion 225B, and the mesh ferrule 16B is press-fitted into the upstream passage 10a3, whereby the mesh 16A is fixed to the first flow path block 12.

As described above, the laminar flow element fixing structure according to the present embodiment includes the bypass adapter 225 that is press-fitted and fixed to the upstream passage 10a3 of the bypass flow path 10a, and the disc spring 224 interposed between the bypass adapter 225 and the laminar flow element 21. The elastic force generated when the bypass adapter 225 presses the disc spring 224 acts on the laminar flow element 21, whereby the laminar flow element 21 is configured to be fixed in close contact with the first flow path block 12 without any gap. Accordingly, gas stagnation is prevented in the bypass flow path 10a, and the bypass sheets constituting the laminar flow element 21 can be brought into sufficiently close contact.

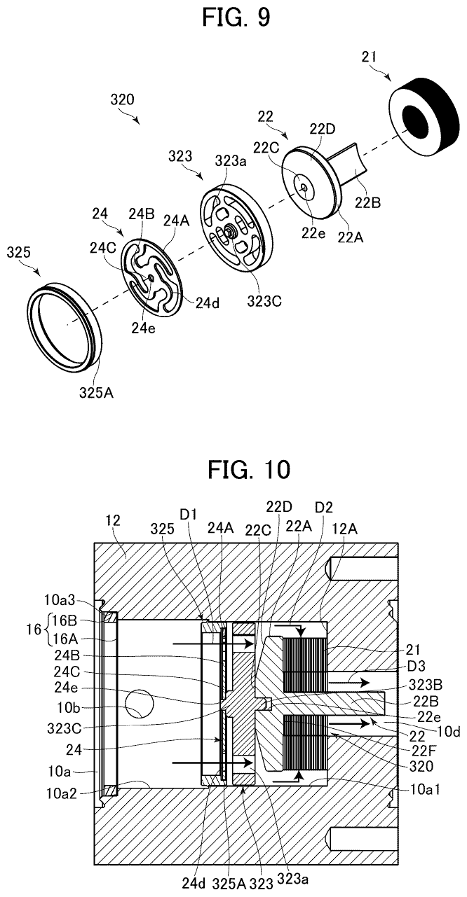

Next, a fixing structure for a laminar flow element according to a fourth embodiment will be described. FIG. 9 is an exploded perspective view of a press-fit unit 320 according to the fourth embodiment, and FIG. 10 is a cross-sectional view of the first flow path block 12, the press-fit unit 320, and the mesh portion 16 according to the fourth embodiment. Members that are the same as those of the press-fit unit 20 according to the first embodiment are denoted by the same reference numerals, and description thereof is omitted.

The press-fit unit 320 includes the laminar flow element 21, the seat pressing member 22, a spring receiver 323, the disc spring 24, and a press-fit collar 325. These members constituting the press-fit unit 320 are made of a steel material such as stainless steel.

The spring receiver 323, which is an auxiliary member, has a generally disk shape and is located on the upstream side of the seat pressing member 22. A plurality (eight) of through-holes 323a are formed in the spring receiver 323. Four through-holes 323a are formed on the inner peripheral side and four through-holes 323a are formed on the outer peripheral side. A first protrusion 323B is provided at a central portion on the downstream side of the spring receiver 323. The first protrusion 323B is fitted into the recess 22e. A second protrusion 323C having a two-step structure is provided at the central portion on the upstream side of the spring receiver 323. An end portion of the second protrusion 323C is fitted into the fitting hole 24e.

The press-fit collar 325, which is a press-fit member, has an annular shape and is located on the upstream side of the disc spring 24. An annular protrusion 325A projecting downstream side is provided on the outer peripheral edge of the press-fit collar 325. The outer peripheral portion 24A of the disc spring 24 is located inside the protrusion 325A.

The press-fit collar 325 is press-fitted into the downstream passage 10a1, whereby the press-fit collar 325 is fixed to the first flow path block 12. The press-fit collar 325 pushes the outer peripheral portion 24A of the disc spring 24 downstream, thereby causing the disc spring 24 to deflect. As a result, an elastic force of the disc spring 24 acts on the spring receiver 323 via the central portion 24C, thereby pushing the spring receiver 323 downstream, and a central portion of the spring receiver 323 presses the seat pressing member 22 downstream. Consequently, the laminar flow element 21 is clamped between the pressing portion 22A of the seat pressing member 22 and the stepped surface 12A of the first flow path block 12, and the laminar flow element 21 is fixed to the first flow path block 12 in close contact without any gap.

As indicated by arrows D1 to D3 in FIG. 10, the fluid passes through the inside of the press-fit collar 325, the through-holes 24d and 323a, passes through a gap between the spring receiver 323 and the inclined surface 22D, then flows through the inside of the laminar flow element 21, and flows into the merging path 10d.

As described above, the fixing structure for the laminar flow element according to the present embodiment includes the press-fit collar 325 press-fitted and fixed to the downstream passage 10a1 of the bypass flow path 10a, and the disc spring 24 interposed between the press-fit collar 325 and the laminar flow element 21. The elastic force generated by the press-fit collar 325 pressing the disc spring 24 acts on the laminar flow element 21, whereby the laminar flow element 21 is configured to be fixed in close contact with the first flow path block 12 without any gap. Accordingly, gas stagnation is prevented in the bypass flow path 10a, and the bypass sheets constituting the laminar flow element 21 can be brought into sufficiently close contact.

The elastic force of the disc spring 24 is configured to act on the laminar flow element 21 via the spring receiver 323. The first protrusion 323B of the spring receiver 323 is fitted into the recess 22e of the seat pressing member 22. This can suppress the influence of tolerances of parts such as the seat pressing member 22 and can suppress axial misalignment of the disc spring 24. Therefore, the spring receiver 323 functions as an auxiliary member that assists the manner in which the elastic force of the disc spring 24 acts on the laminar flow element 21.

The present disclosure is not limited to the embodiments described above. Those skilled in the art can make various additions, modifications, and the like within the scope of the present disclosure.

For example, stainless steel has been exemplified as the material for the body 10, the press-fit unit 20, and the mesh portion 16; however, a usable material (including metal, non-metal, resin material, and the like) and shapes may be selected according to the fluid to be controlled, the place of use, and the like. Although the flow rate control device 1 is a mass flow controller in the above description, the present disclosure is not limited thereto as long as the device is one to which the fixing structure for a laminar flow element is applicable. The flow rate control device 1 may be a mass flow meter or any other device. Although the elastic body has been described as the disc springs 24 and 224 and the coned disc spring 124, the elastic body is not limited thereto and may be another elastic member such as a leaf spring.

What is claimed is:

1. A fixing structure for a laminar flow element fixed to a flow path block having a flow path, comprising:
a press-fit member press-fitted and fixed to the flow path; and
an elastic body interposed between the press-fit member and the laminar flow element,
wherein the laminar flow element is configured to be fixed to the flow path block by an elastic force that is generated by the press-fit member pressing the elastic body and that acts on the laminar flow element.

2. The fixing structure for a laminar flow element according to claim 1, wherein an auxiliary member is provided between the laminar flow element and the press-fit member, the auxiliary member assisting a manner in which the elastic force of the elastic body acts on the laminar flow element.

3. The fixing structure for a laminar flow element according to claim 1, wherein a mesh is fixed in the flow path.

4. A flow rate control device using the fixing structure for the laminar flow element according to claim 1.
